(19) United States
(12) Patent Application Publication
(10) Pub. No.: US 2019/0303929 A1
(43) Pub. Date: Oct. 3, 2019

(54) USING OUT-OF-BAND MOBILE DEVICE POSSESSION ATTESTATION TO RELEASE VERIFIED USER IDENTITY ATTRIBUTES DURING INTERNET TRANSACTIONS

(71) Applicant: Averon US, Inc., Henderson, NV (US)

(72) Inventors: Wendell BROWN, Henderson, NV (US); Mark KLEIN, Henderson, NV (US)

(21) Appl. No.: 16/365,816

(22) Filed: Mar. 27, 2019

Related U.S. Application Data
(60) Provisional application No. 62/648,638, filed on Mar. 27, 2018.

(51) Int. Cl. G06Q 20/38; H04L 29/06; G06Q 20/32; G06Q 20/40; H04W 12/00; H04W 12/06; H04W 12/10; G06F 16/22

(52) U.S. Cl. CPC G06Q 20/38215; H04L 63/0853; G06Q 20/32; G06F 16/2255; H04W 12/00512; H04W 12/06; H04W 12/1008; G06Q 20/4014

(57) ABSTRACT

Systems, methods, apparatuses, and computer readable media facilitating release of verified user identity attributes during internet transactions. One example method may comprise receiving, at an identity authentication system, via network, from a service provider, an indication that the service provider received a request for service from a user device, receiving, via a carrier network, at the identity authentication system, information indicative of device identification information, receiving, via the network, from the service provider, a request for a user identity package, accessing a user identify package manager to extract service-provider-specific user attributes, and returning, in response to the request, via the network, to the service provider, a service-provider-specific user identity package.

### CROSS-REFERENCE TO RELATED APPLICATIONS

This application claims priority to U.S. Provisional Application No. 62/648,638 filed Mar. 27, 2018, the content of which is incorporated herein by reference in its entirety.

### TECHNOLOGICAL FIELD

Embodiments of the invention relate, generally, to identity authenticity verification, and more specifically to using out-of-band mobile device possession attestation to release verified user identity attributes during internet transactions.

### BACKGROUND

Fake social media accounts, bot-generated Internet postings, and propaganda (“fake news”) promulgated by scores of troll farm workers often sponsored by hostile foreign powers have been responsible for socially engineered election tampering in the United States and elsewhere. The root enabler of this problem is the complete anonymity afforded by the Internet. Anonymity was a design objective in the development of the Internet. To date, when a user interacts with Internet services, they self-report their identity, or attributes of their identity. As an example, it is trivial for a person to sign up for one or more social media accounts using one or more pseudonyms to protect or to obfuscate their real identity.

This lack of on-line identity has led to an erosion of trust on the Internet, trust of the government, and trust in society at large. This lack of identity and concomitant lack of accountability has allowed the sowing of discord in the United States and elsewhere. Many people don't know if what they read and see online is factual or fictional. Rational online discourse is being swamped out by surreptitiously sourced articles, comments, and reviews given enhanced status by throngs of secret troll farm workers. There is a growing feeling that an individual does not have a voice against this din of secretly orchestrated propaganda and disinformation. As one example, “[a]s many as 2 million comments on the US Federal Communications Commission's proposal to repeal net neutrality rules were faked,” according to the office of the attorney general of New York.

In a more personal sphere, there are countless cases of online bullying from people hiding behind fake or counterfeit social media profiles. The authenticity of online ratings of businesses, products, or services is often discounted because it is widely understood that one person can create a multitude of accounts and either raise or lower such ratings. This is especially true for newly rated entities that have a small number of ratings, the majority of which may be coming from a single person using multiple, easily created, accounts.

Moreover, there is growing, justifiable fear that a person's identity will be stolen causing a multitude of problems, both financial and social, to befall the victim. This fear has increased after it was revealed that every Yahoo account had been breached and over 145 million people had been affected by the massive Equifax data breach.

The applicant has discovered problems with current systems, methods, and apparatuses utilized for user identification on the internet, and through applied effort, ingenuity, and innovation, Applicant has solved many of these identified problems by developing a solution that is embodied by the present invention, which is described in detail below.

### BRIEF SUMMARY

In general, embodiments of the present invention provided herein include systems, methods, apparatuses, and computer readable media for using out-of-band mobile device possession attestation to release verified user identity attributes during internet transactions.

In some embodiments, a method may be provided for facilitating release of verified user identity attributes during internet transactions, the method comprising receiving, at an identity authentication system, via network, from a service provider, an indication that the service provider received a request for service from a user device, receiving, via a carrier network, at the identity authentication system, information indicative of device identification information, receiving, via the network, from the service provider, a request for a user identity package, accessing a user identify package manager to extract service-provider-specific user attributes, and returning, in response to the request, via the network, to the service provider, a service-provider-specific user identity package.

In some embodiments, the device identification information is a mobile phone number associated with the user device. In some embodiments, the service-provider-specific user identity package comprises information indicative of a set of identity attributes selected by the user.

In some embodiments, the method may further comprise receiving an opt-in indication, the opt-in indication authorizing release of the service-provider-specific user identity package to the service provider. In some embodiments, the method may further comprise determining that an opt-in indication has not been received, the opt-in indication authorizing release of the service-provider-specific user identity package to the service provider, and providing, to the service provider, an indication that the opt-in indication has not been received, configured to cause the service provider to prompt the user device to provide the opt-in indication.

In some embodiments, the method may further comprise performing a secondary authentication process, including a verification of a biometric information. In some embodiments, the method may further comprise receiving, at the user identify package manager, at least a portion of the service-provider-specific user attributes. In some embodiments, the method may further comprise storing the portion of the service-provider-specific user attributes to a blockchain, indexed by a hash of the device identification information. In some embodiments, the method may further comprise storing, to a blockchain, and indexed by a hash of the device identification information, information indicative of at least one of the request for the user identity package and the service provider from which the request for the user identity package was received.

In some embodiments, the method may further comprise storing, to a blockchain, and indexed by a hash of the device identification information, information indicative of at least one of information indicative of the return, in response to the request to the service provider, of the service-provider-specific user identity package and the service provider to which the return was transmitted and from which the request for the user identity package was received.

In some embodiments, an apparatus may be provided for facilitating release of verified user identity attributes during internet transactions, the apparatus comprising at least one processor and at least one memory including computer program code, the at least one memory and the computer program code configured to, with the processor, cause the apparatus to at least receive, at an identity authentication system, via network, from a service provider, an indication that the service provider received a request for service from a user device, receive, via a carrier network, at the identity authentication system, information indicative of device identification information, receive, via the network, from the service provider, a request for a user identity package, access a user identify package manager to extract service-provider-specific user attributes, and return, in response to the request, via the network, to the service provider, a service-provider-specific user identity package.

In some embodiments, the device identification information is a mobile phone number associated with the user device. In some embodiments, the service-provider-specific user identity package comprises information indicative of a set of identity attributes selected by the user.

In some embodiments, the at least one memory and the computer program code are further configured to, with the processor, cause the apparatus to receive an opt-in indication, the opt-in indication authorizing release of the service-provider-specific user identity package to the service provider. In some embodiments, the at least one memory and the computer program code are further configured to, with the processor, cause the apparatus to determine that an opt-in indication has not been received, the opt-in indication authorizing release of the service-provider-specific user identity package to the service provider, and provide, to the service provider, an indication that the opt-in indication has not been received, configured to cause the service provider to prompt the user device to provide the opt-in indication.

In some embodiments, the at least one memory and the computer program code are further configured to, with the processor, cause the apparatus to perform a secondary authentication process, including a verification of a biometric information. In some embodiments, the at least one memory and the computer program code are further configured to, with the processor, cause the apparatus to receive, at the user identify package manager, at least a portion of the service-provider-specific user attributes.

In some embodiments, the at least one memory and the computer program code are further configured to, with the processor, cause the apparatus to store the portion of the service-provider-specific user attributes to a blockchain, indexed by a hash of the device identification information.

In some embodiments, the at least one memory and the computer program code are further configured to, with the processor, cause the apparatus to store, to a blockchain, and indexed by a hash of the device identification information, information indicative of at least one of the request for the user identity package and the service provider from which the request for the user identity package was received.

In some embodiments, the at least one memory and the computer program code are further configured to, with the processor, cause the apparatus to store, to a blockchain, and indexed by a hash of the device identification information, information indicative of at least one of information indicative of the return, in response to the request to the service provider, of the service-provider-specific user identity package and the service provider to which the return was transmitted and from which the request for the user identity package was received.

In some embodiments, a computer program product may be provided for facilitating release of verified user identity attributes during internet transactions, the computer program product comprising at least one non-transitory computer-readable storage medium having computer-executable program code instructions stored therein, the computer-executable program code instructions comprising program code instructions for receiving, at an identity authentication system, via network, from a service provider, an indication that the service provider received a request for service from a user device, receiving, via a carrier network, at the identity authentication system, information indicative of device identification information, receiving, via the network, from the service provider, a request for a user identity package, accessing a user identify package manager to extract service-provider-specific user attributes, and returning, in response to the request, via the network, to the service provider, a service-provider-specific user identity package.

In some embodiments, the device identification information is a mobile phone number associated with the user device. In some embodiments, the service-provider-specific user identity package comprises information indicative of a set of identity attributes selected by the user.

In some embodiments, the computer-executable program code instructions further comprise program code instructions for receiving an opt-in indication, the opt-in indication authorizing release of the service-provider-specific user identity package to the service provider. In some embodiments, the computer-executable program code instructions further comprise program code instructions for determining that an opt-in indication has not been received, the opt-in indication authorizing release of the service-provider-specific user identity package to the service provider, and providing, to the service provider, an indication that the opt-in indication has not been received, configured to cause the service provider to prompt the user device to provide the opt-in indication.

In some embodiments, the computer-executable program code instructions further comprise program code instructions for performing a secondary authentication process, including a verification of a biometric information. In some embodiments, the computer-executable program code instructions further comprise program code instructions for receiving, at the user identify package manager, at least a portion of the service-provider-specific user attributes.

In some embodiments, the computer-executable program code instructions further comprise program code instructions for storing the portion of the service-provider-specific user attributes to a blockchain, indexed by a hash of the device identification information. In some embodiments, the computer-executable program code instructions further comprise program code instructions for storing, to a blockchain, and indexed by a hash of the device identification information, information indicative of at least one of the request for the user identity package and the service provider from which the request for the user identity package was received.

In some embodiments, the computer-executable program code instructions further comprise program code instructions for storing, to a blockchain, and indexed by a hash of the device identification information, information indicative of at least one of information indicative of the return, in response to the request to the service provider, of the service-provider-specific user identity package and the service provider to which the return was transmitted and from which the request for the user identity package was received.

Other systems, methods, and features will be, or will become, apparent to one with skill in the art upon examination of the following figures and detailed description. It is intended that all such additional systems, methods, features to be included within this description, be within the scope of the disclosure, and be protected by the following claims.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates an example system within which embodiments of the present invention may operate.

FIG. 2 illustrates a block diagram showing an example apparatus for facilitating user identity authentication, in accordance with some exemplary embodiments of the present invention.

FIG. 3 illustrates an example system and data flow, within which embodiments of the present invention may operate.

FIG. 4 illustrates a flowchart depicting example operations for authenticating a user identity and releasing verified user identity attributes, in accordance with some example embodiments discussed herein.

FIG. 5 illustrates a flowchart depicting example operations for facilitating reception of user attributes, in accordance with some example embodiments discussed herein.

FIG. 6 illustrates a flowchart depicting example operations for facilitating an opt-in process, in accordance with some example embodiments discussed herein.

FIG. 7 illustrates a flowchart depicting example operations for performing secondary authentication, in accordance with some example embodiments discussed herein

### DETAILED DESCRIPTION

Embodiments of the present invention now will be described more fully hereinafter with reference to the accompanying drawings, in which some, but not all, embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

As used herein, the terms “data”, “content”, “information”, and similar terms, may be used interchangeably to refer to data capable of being captured, transmitted, received, displayed, and/or stored in accordance with various example embodiments. Thus, use of any such terms should not be taken to limit the spirit and scope of the disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, and/or the like, sometimes referred to herein as a “network.” Where multiple networks are described, it will be appreciated that each network in the multiple networks may utilize entirely different components, share some components, share all components, and otherwise be configured such that a first network and a second network may be entirely separate networks, partially the same network, or entirely the same network.

### Overview

Embodiments of the present invention provided herein include systems, methods, apparatuses, and computer readable media directed to a general concept that one's unique identity on the Internet is one's obfuscated mobile phone number, and by facilitating release of verified user identity attributes during internet transactions to service provider, thereby enabling verification of the authenticity of a user's identity and/or a uniqueness of a user, for example, when they submit information (e.g., a review, or the like) to the service provider, the information may be more trustworthy (e.g., not fake).

In particular, by associating a user and/or user device with their mobile telephone number at the time of an internet transaction, consumers of any information submitted by that user during the internet transaction can have confidence that the user and information is real.

As such, the identity authentication system described herein provides a universal, cross-app/cross-website identity verification solution. Utilizing the identity authentication system, each participating service provider may gain access to a user's opted-in identity attributes every time the user interacts with that service provider.

Any service provider may initiate the sign up/opt-in process for a user. Information shared with the identity authentication system by the user may then be made available for any service provider, for example, via a user opt-in. As such, there is no need, for example, for a user to submit a driver's license to each service provider. Once submitted and verified by the system, it is available to be shared, at the user's selective discretion, with every service provider.

Moreover, the identity authentication system enables selection (e.g., by the user operating the user device) to have/submit an anonymous unique identity shared on a service-provider-by-service-provider opt-in basis, by service provider category (e.g., financial institutions, but not advertisers, or the like), or freely among all service providers wherever they venture on the Internet in a perpetual, time-limited window, or one-time use. This would be analogous to an identifying cookie that could be accessed by any participating service provider qualified by user selected opt-in rules (specific service providers, by category, blanket opt-in, etc.).

The identity authentication system enables anonymity to be selectively retained by the user, for example when reporting bullying or a crime, or interacting with a service provider with which the user chooses to remain anonymous.

The system enables a user to selectively release and convey their identity, or attributes of their identity to service providers. As such, network (e.g., internet) transactions, such as postings, reviews, articles, comments, and the like, are able to be made anonymously while a ‘consumer of the information entered during these transactions’ (e.g., a reader of a review) can be confident the user is a real person.

Identity attributes may include, for example, confirmed unique existence (possibly anonymously, without linkage to the actual person), nationality, residency, age, first name, full name, military service membership, club membership, professional qualifications, etc. The system makes fake news articles submitted or endorsed by troll farms apparent, and it makes the authorship of authentic articles trustworthy.

Security laws in many countries require wireless carriers to confirm the actual identity of a person opening an account. In the United States, carriers have 30 days to complete this verification. In some countries, verification must be completed before service is initiated. Countries in which such verification laws are in force, increase the confidence in the uniqueness and authenticity of a user. The system provides for an authenticity scale (or rating) for each user. The system considers laws (and their level of enforcement) in the jurisdiction of the mobile phone account when assigning a confidence rating to a user's identity.

### Definitions

Some example embodiments will now be described more fully hereinafter with reference to the accompanying drawings, in which some, but not all embodiments are shown. Indeed, the example embodiments may take many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, hosts, and/or the like.

Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

The term network address, as used herein, for example, may refer to a uniform resource locator (“URL”), an internet protocol (IP) address, a phone number, voice over IP (“VOIP”) identification number, or the like and generally be configured to be passed to the secured system or directly to the user device, for the user device to ping or otherwise access.

The term “device identification information” as used herein refers to any information that may identify a computing device. For example, device identification information may refer to a user's subscriberID, which may be similar or the same as a mobile device's phone number/CallerID number, the mobile device's phone number, the mobile device's callerID number, International Mobile Equipment Identity (IMEI)/unique serial number (ICCID) data, network-based, MAC addresses, billing record's modem certificate, DOCSIS hub/Media Access Layer routing assignments, Cable modem's certificate, device serial number, etc., Intel vPro and Trusted Platform Module key, or the like. In a mobile context, device identification information may refer to a subscriber identification module (SIM), embodied by SIM cards, which are configured to store network-specific information used to authenticate and identify subscribers on a network, and may further be embodied by e-sims, programmable sims, virtual sims, apple sims, or the like, Universal Subscriber Identity Module (USIM), a Removable User Identity Module (R-UIM), or a CDMA Subscriber Identity Module (CSIM), any of which may be a software application or integrated circuit, for example, stored on a SIM card or Universal Integrated Circuit Card (UICC), may comprise at least a unique serial number (ICCID), an international mobile subscriber identity (IMSI) number, Authentication Key (Ki), Local Area Identity (LAI), and Operator-Specific Emergency Number. SIM cards also store other carrier specific information such as, for example, the SMSC (Short Message Service Center) number, Service Provider Name (SPN), Service Dialing Numbers (SDN), Advice-Of-Charge parameters, and Value Added Service (VAS) application. The SIM card, as referred to herein, may be a full, mini, micro, nano, virtual, programmable, software (e.g., “soft” sim), an Apple®, or an emdedded(e) SIM. In some embodiments, device identification information may be contained within, stored on, or otherwise embodied by an EMV (Europay, MasterCard and Visa) chip or an NFC (Near Field Communication) chip with, for example, unique account information.

Device identification information may be stored, transmitted, and/or received, in some embodiments, in a raw, tokenized, hashed, one-way hashed, encrypted, digitally signed, using public/private key encryption or other means of encrypting, or other similar algorithms (e.g., for system/customer/bank/wireless network/other privacy or other reasons) data form, or otherwise derived or transcoded from any of the above.

A “computing device”, as used herein, may refer to mobile devices utilizing mobile apps, computers using browsers, kiosks designed for a particular purpose, and/or physical devices, vehicles, locks (e.g., home or automobile entry or the like), home appliances and other items embedded with any of electronics, software, sensors, and/or actuators, as well as network connectivity which enables these objects to connect and exchange data.

A “user device”, as used herein, may refer to a device (e.g., a mobile device) configured to interact with a service provider and/or other user devices through one or more networks. Examples of a user device may include a laptop, mobile device (e.g., smartphone and other mobile devices), tablet, personal computer, chip embedded card, credit card, debit card, key fob, or the like, or any combination thereof.

A “network provider” as used herein may be, for example, wireless network provider (e.g., Verizon, AT&T, T-Mobile, etc.) which may have data such as a user's name, billing address, equipment installation address, birthdate, tower routing/router information to the user's wireless device (e.g., mobile phone), IP WAN address, IP LAN address, IP DMZ info, wireless device equipment information (serial number, certificate number, model number, IMEI number etc.), and other information, that it could similarly supply to a third-party.

Similarly, a “network provider” may be, for example, in those embodiments in which a user may access the internet through a wired connection (e.g., via cable, DSL, any non-wireless-phone-carrier means such as via a satellite dish system), a wired network provider. For example, a user's cable company (for example: cox cable) may have data such as a user's name, billing address, equipment installation address, birthdate, among other fields, cable wire routing/router information to the user's cable modem (home), IP WAN address, IP LAN address, IP DMZ info, cable modem equipment information (serial number, certificate number, model number, etc.), and other information, that it could similarly supply to a third-party.

The term “network” refers to one or more servers, relays, routers, network access points, base stations, and/or the like, capable of transmitting information and/or requests between computing devices. For example, in some embodiments, a network may be a mobile carrier network. A person having ordinary skill in the art would understand a “carrier network”, “mobile carrier”, or the like refers to a telecoms network infrastructure provided by a telecoms service provider. In another embodiment, a network may refer to a Wi-Fi network, WLAN, LAN, WAN, or the like. In some embodiments, a “first network” and a “second network” may refer to two separate networks. Alternatively, in some embodiments, a “first network” and a “second network” may refer to the same network, such that the first and second networks transmit information over some shared components or all shared components. Further, in some embodiments, a “first network” and a “second network” may be used to indicate that the two networks are out-of-band with respect to one another.

One having ordinary skill in the art would readily recognize the term “out-of-band” refers to a network or data channel that is separate from a primary network or data channel. For example, in some embodiments, a device network may be out-of-band from a communications network. In some embodiments, the device network may be a carrier network while the communications network may be a Wi-Fi or WLAN network.

A “service provider” refers to any entity that provides services to a user via a user device and/or computing device. For example, a service provider may be an online retailer, software as a service provider, other e-commerce business, or the like. A “secured system” as used herein may refer to a service provider, or a subset of service providers that may include, for example, any organization, person, company, government, or other entity seeking to provide a secure data environment, including, for example, a bank, an e-commerce company, an entertainment company, an IOT device/company, (IOT meaning internet of things), a fintech company, a social web company, a file storage company, or the like.

A service provider may be associated with “service provider identification information” that uniquely identifies the service provider. For example, service provider identification information may comprise a combination of attributes associated with service provider (e.g., a service provider name, location, or the like).

The term “header enrichment” refers to a process for authenticating a mobile device or an owner of the mobile device via a Direct Autonomous Authentication process, involving a packet header enrichment in which packet headers comprise device identification information, for example, “injected” therein by a trusted party such as a carrier, network provider or through a login process. For example, in some embodiments, a network may inject a phone number associated with a mobile device within packet headers. In this manner, the authentication system may obtain device identification information without user input. Application Ser. No. 15/424,595, entitled “Method and Apparatus for Facilitating Frictionless Two-Factor Authentication,” filed on Feb. 3, 2017, which is hereby incorporated by reference in its entirety, describes a number of exemplary processes for performing a Direct Autonomous Authentication process.

The term “biometric indicator” refers to data representing a biometric feature associated with a user. Examples of a biometric indicator include, but are not limited to, a fingerprint scan, a face scan, an iris scan, and a walking gait.

The term “ledger” refers to a log of transactions, such as a log of transaction reports, wherein the log of transactions allows auditing by authorized parties. In some embodiments, the ledger may be stored in a transaction database. In an additional embodiment, the ledger may be stored via a blockchain, such that each new transaction reports is appended to the end of the chain.

### Technical Underpinnings and Implementation of Exemplary Embodiments

An identity authentication system 102 in accordance with an embodiment of the invention herein may be configured to selectively release service provider specific user attributes, utilizing out-of-band mobile device possession attestation, thereby providing verification of a user's identity and/or where anonymity is preferred or required, verification of the uniqueness of the user.

As touched upon earlier, conventional systems make it trivial for a user to make more than one account, to make fake accounts, or otherwise remain completely anonymous, thereby generating eroding confidence of any information on the internet.

Improvement lies, at least, in the use of out-of-band mobile device possession attestation for use in identity authentication. The system's association of verified user identity, even when anonymity is retained by the user, with the transactions (e.g., postings, reviews, etc.) they make on the Internet, increases the trustworthiness of Internet content and redresses or mitigates many of the problems currently endemic on the Internet. It suppresses fake news and its propagation, reduces online bullying, and as a result of these influences, would therefore be expected to increase engagement with Internet services. The system allows everyone to see clearly who is real online and who is not and thereby permits users to feel they have a voice and can be recognized equally.

Furthermore, the system may be used to log users into services with or without a user name and password. That is, when used in conjunction with conventional systems, that require a user name and password, the system provides a second authentication factor with no effort required of the user. When used without a password, the system may provide a single sign on solution, allowing the user to switch seamlessly among a multitude of service provider apps and websites. In this configuration, the system may allow universal login that requires little or no user action.

In some embodiments, when the system is used for universal login, the reduced barrier to logging in to multiple services reduces user frustration and increases engagement with Internet services. Each service provider may then check the user's identity confidence level before granting the user services. Service providers may determine what level is required for each service they provide. For example, a social media site may allow a user to login solely with the base level of anonymous identity, possibly also requiring biometric confirmation on the mobile device. A bank would likely require a much higher level of identity confidence level (and possibly requiring minimal subsets of confirmed identity attributes—for example, a passport, or a driver's license combined with a phone number linked utility account) for user login and possibly an even higher level for high-value transactions.

### System Architecture

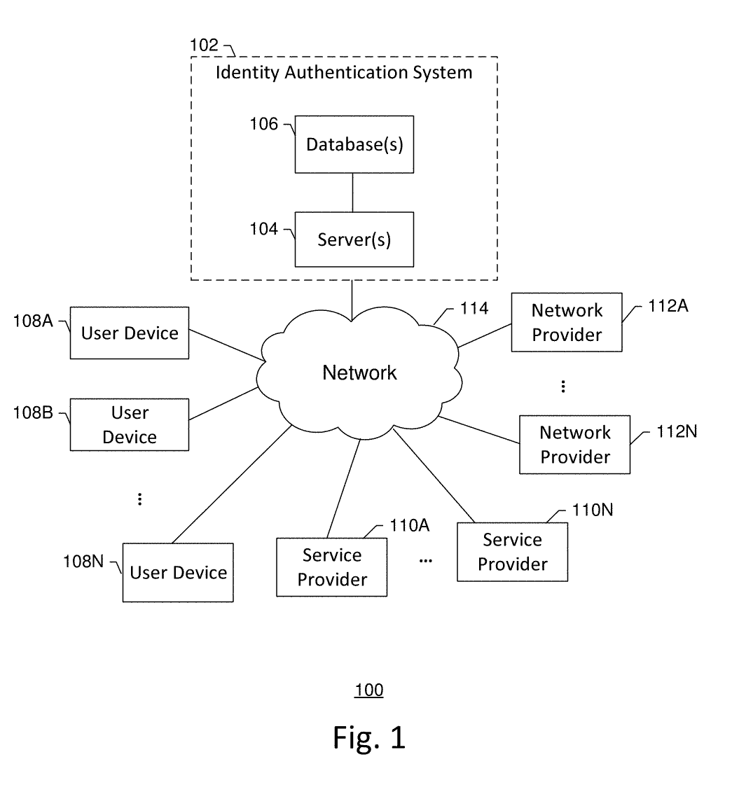

FIG. 1 is a system diagram showing an exemplary system, which may include one or more devices and sub-systems that are configured to implement embodiments discussed herein, and in particular, to implement an identity authentication process via an identity authentication system 102.

Turning to the FIG. 1, the system may include identity authentication system, including server 104 and database 106, one or more user devices 108A, 108B, and 108N, network providers 112A-112N, and service providers 110A-110N. Server 104 may include any suitable network server and/or other type of processing device to communicate with other devices via one or more networks, such as Network 114.

Identity authentication system, user devices 108A, 108B, and 108N, network providers 112A-112N, and service providers 110A-110N may be configured to communicate with each other over a network, such as network 114, which may be the Internet or the like. In some embodiments, the network by which user devices 108A, 108B, and 108N may be configured to communicate with identity authentication system, network providers 112A-112N, and service providers 110A-110N may be different or “out of band” with network 114.

In some embodiments, user devices 108A, 108B, and 108N may be a smartphone, mobile device, tablet device, kiosk device, internet of things (IoT) device, an automobile or device coupled to an automobile, or other electronic device. In some embodiments, user devices 108A, 108B, and 108N may include one or more sensors configured to detect, identify, or receive a biometric trait. For example, in an exemplary system, one or more of user devices 108A, 108B, and 108N may be a smartphone with a hardware configured to perform a fingerprint scan, iris scan, a facial recognition scan, or the like.

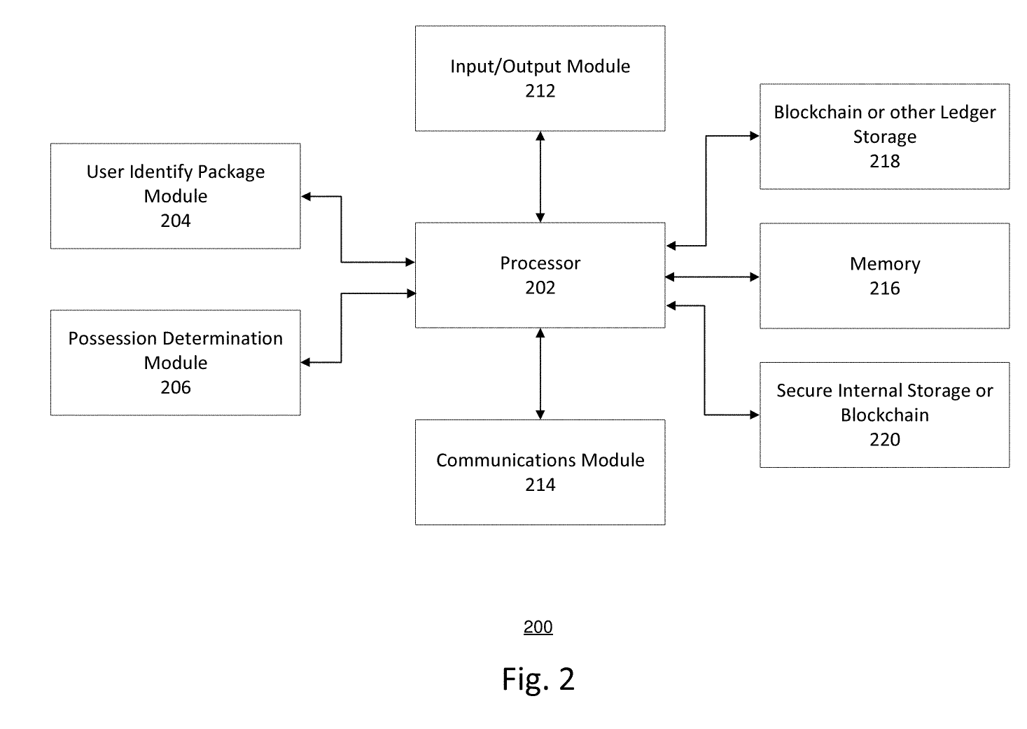

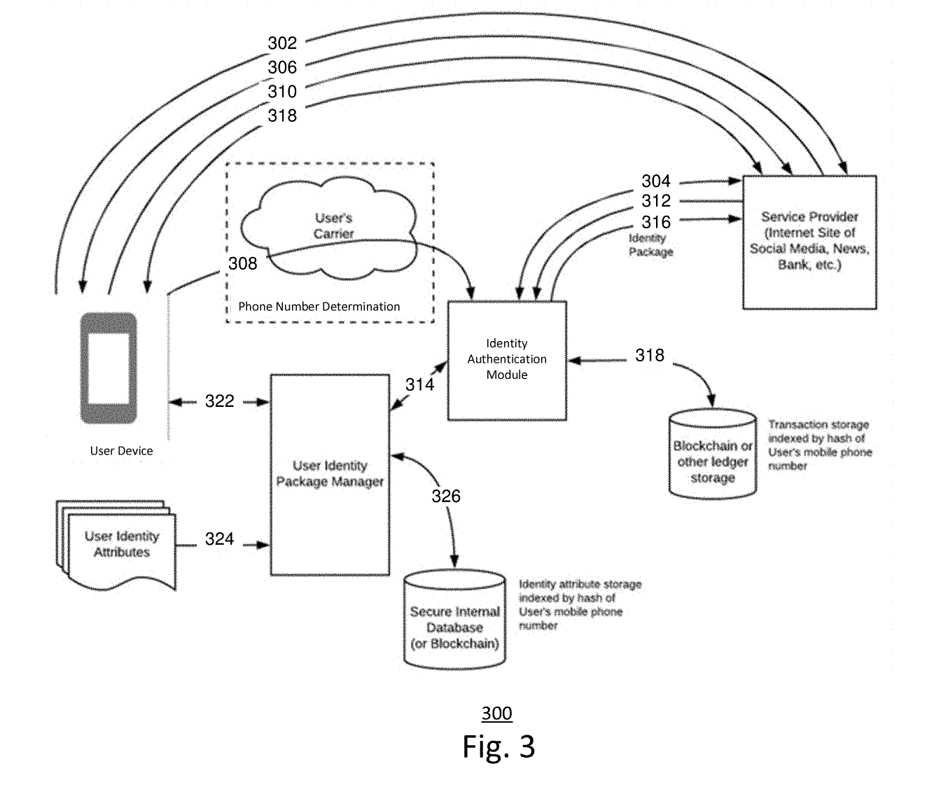

Identity authentication system may be embodied by one or more computing systems, such as apparatus 200 shown in FIG. 2. As illustrated in FIG. 2, the apparatus 200 may include a processor 202, a user identity package module 204, a possession determination module 206, input/output module 212, communications module 214, a memory 216, location history storage 218, and possession history 220. The apparatus 200 may be configured to execute the operations described above with respect to FIG. 1, and below with respect to FIGS. 3, 4, 5, 6, and 7. Although the components are described with respect to functional limitations, it should be understood that particular implementations necessarily include the use of particular hardware. It should also be understood that certain of these components 202-220 may include similar or common hardware. For example, two sets of circuitry may both leverage use of the same processor, network interface, storage medium, or the like to perform their associated functions, such that duplicate hardware is not required for each module. The use of the term “module” as used herein with respect to components of the apparatus should therefore be understood to include particular hardware configured to perform the functions associated with the particular module as described herein.

The term “module” should be understood broadly to include hardware and, in some embodiments, software for configuring the hardware. For example, in some embodiments, “module” may include processing circuitry, storage medium, network interfaces, input/output devices, and the like. In some embodiments, other elements of the apparatus 200 may provide or supplement the functionality of a particular module, or particular modules. For example, the processor 202 may provide processing functionality, the memory 216 may provide storage functionality, the communications module 214 may provide network interface functionality, and the like.

In some embodiments, the processor 202 (and/or co-processor and any other processing module assisting or otherwise associated with the processor) may be in communications with the memory 216 via a bus for passing information among components of the apparatus. The memory 216 may be non-transitory and may include, for example, one or more volatile and/or non-volatile memories. In other words, for example, the memory may be an electronic storage device (e.g., a computer readable storage medium). The memory 216 may be configured to store information, data, content, applications, instructions, or the like, for enabling the apparatus to carry out various functions in accordance with example embodiments of the present invention.

The processor 202 may be enabled in a number of different ways and may, for example, include one or more processing devices configured to perform independently. Additionally or alternatively, the processor may include one or more processors configured in tandem with a bus to enable independent execution of instructions, pipelining, and/or multithreading. The use of the term “processing module” may be understood to include a single core processor, a multi-core processor, multiple processors internal to the apparatus, and/or remote or “cloud” processors.

In an example embodiment, the processor 202 may be configured to execute instructions stored in the memory 216 or otherwise accessible to the processor. Alternatively or additionally, the processor may be configured to execute hard-coded functionality. As such, whether configured by hardware or software methods, or by a combination thereof, the processor may represent an entity (e.g., physically embodied in the circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the apparatus 200 may include input/output module 212 that may, in turn, be in communication with processor 202 to provide output to the user and, in some embodiments, to receive an indication of a user input. The input/output module 212 may comprise a user interface and may include a display and may comprise a web user interface, a mobile application, a client device, a kiosk, or the like. In some embodiments, the input/output module 212 may also include a keyboard, a mouse, a touch screen, touch areas, soft keys, a microphone, a speaker, or other input/output mechanisms. The processor 202 and/or a user interface module comprising the processor may be configured to control one or more functions of one or more user interface elements through computer program instructions (e.g., software and/or firmware) stored on a memory accessible to the processor (e.g., memory 216, and/or the like).

The communications module 214 may be any means such as a device or circuitry embodied in either hardware or a combination of hardware and software that is configured to receive and/or transmit data from/to a network and/or any other device, circuitry, or module in communication with the apparatus 200. In regard, the communications module 214 may include, for example, a network interface for enabling communications with a wired or wireless communication network. For example, the communications module 214 may include one or more network interface cards, antennae, buses, switches, routers, modems, and supporting hardware and/or software, or any other device suitable for enabling communications via a network. Additionally or alternatively, the communications interface may include the circuitry for interacting with the antenna(s) to cause transmission of signals via the antenna(s) or to handle receipt of signals received via the antenna(s).

User identity package module 204 includes hardware and software configured to generate and/or provide a service provider specific user identity package. In particular, user identity package module 204 may be configured to receive, in conjunction with an interaction with a service provide or independently, user attributes. Additionally or alternatively, user identity package module 204 may be configured to receive input from a user, via a user device, indicative of one or more selection indicating which zero or more user attributes may be authorized to be provided to each of one or more service providers, such that when generating the service provider specific user identity package, the selected user attributes may be included. In some embodiments, user identity package module 204 may receive information via a network interface provided by the communications module 214. Furthermore, user identity package module 204 may be configured to utilize processor 202 to perform the operations described herein. However, it should also be appreciated that, in some embodiments, user identity package module 204 may include a separate processor, specially configured field programmable gate array (FPGA), or application specific interface circuit (ASIC) to perform these operations. User identity package module 204 is therefore implemented using hardware components of the apparatus configured by either hardware or software for implementing these planned functions.

Possession determination module 206 includes hardware and software configured to facilitate possession determination. Additionally or alternatively, possession determination module 206 may be configured to determine user possession of a user device. Possession determination module 206 may receive information via a network interface provided by the communications module 214. However, it should also be appreciated that, in some embodiments, possession determination module 206 may include a separate processor, specially configured field programmable gate array (FPGA), or application specific interface circuit (ASIC) to perform the possession determination. Possession determination module 206 is therefore implemented using hardware components of the apparatus configured by either hardware or software for implementing these planned functions.

In some embodiments, identity authentication system such as apparatus 200 may include any of one or more of memory 216, blockchain or other ledger storage 218, and secure internal storage 220 (herein, referred to as memory 216). Memory 216 includes hardware and software configured to facilitate storage of information indicative of each request for a user identity package received from a service provider. Furthermore, memory 216 may be configured to store information indicative of the service provider from which the request was received. Memory 216 may be further configured to store information indicative of indicative of the return, in response to the request, and the service provider to which the return was transmitted and from which the request for the user identity package was received. In each case, memory 216 may be configured to store the information, indexed by the identification information or a hash of the device identification information. For example, during identity authentication process, as requests are received, the data, or some portion thereof, may be stored, for example, periodically, the identification information or a hash of the device identification information. Additionally or alternatively, memory 216 may be configured to add, delete, or release stored information to third-parties, such as, for example, service providers, secured systems, or the like. Additionally or alternatively, in some embodiments, memory 216 may be configured to allow the system to selectively release a portion of the information. In some embodiments, memory 216 may be configured to perform filtering, for example, by device, by user, by time, or a time period, or the like to identify information for use in responding to a request.

As will be appreciated, any such computer program instructions and/or other type of code may be loaded onto a computer, processor, or other programmable apparatus' circuitry to produce a machine, such that the computer, processor other programmable circuitry that execute the code on the machine created the means for implementing various functions, including those described herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware.

Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

### Data Flow

FIG. 3 depicts an example data flow 300 illustrating interactions between an identity authentication system (e.g., identity authentication system 102 described above), a user device, for example, one of user devices 108A-108N, a service provider, such as one of service providers 110A-1104N, and a network provider, such as one of network providers 112A-112N. The data flow 300 illustrates how electronic information may be passed among various systems in accordance with embodiments of the present invention.

At step 302, service is requested, for example, by user device 108A from service provider 110A. In the most general sense, the request for service may be any action for which identity verification may be desired. For example, a request for service may include logging in, attempting to post an article, comment, review, or the like. In some embodiments, step 302 may also comprise opting-in by the user device. Opting in may signal to the service provider and, by extension, the identity authentication system 102, that the user of the user device authorizes release of certain identity attributes. If the request does not comprise an indication of opting-in or no opt-in has been previously received, no further action may be taken.

However, in the event that the opt-in is received, the service provider provides an indication to the identity authentication system that the service provider received a request for service from the user device, and in some embodiments, receives session identification information in return, at step 304.

At step 306, the service provider may provide information indicative of a request for an identity of the user, the user device, or the like (e.g., an anonymous unique identity). At step 308, a JavaScript or other call may be made to acquire the mobile phone number, for example, associated with the user device that is requesting service from the service provider. For example, in some embodiments, the carrier network (e.g., the user's carrier network) may inject a phone number associated with the user device within packet headers. That is, in some embodiments, the mobile device or an owner of the mobile device may be identified and/or authenticated via a Direct Autonomous Authentication process, which comprises packet header enrichment in which packet headers comprise device identification information, for example, “injected” therein by a trusted party such as a carrier network, network provider or through a login process. In this manner, the authentication system may obtain device identification information without user input.

At step 310, the user device may then provide a notification to the service provider indication of, for example, completion of the action necessary to provide the requested identity (e.g., the anonymous unique identity). The service provider, upon receiving this notification, at step 312, may provide a request to the identity authentication system, for a user identity package. In some embodiments, the request may comprise service provider identification information configured to, for example, identify the service provider, and additionally or alternatively, comprise the session identifier received previously.

Because the identity authentication system allows selection of particular user attributes authorized to be released to particular service providers, a service provider specific user identity package may be accessed from or generated by the user identity package manager at step 314. At step 316, the identity authentication system may provide, in return to the request, the service provider specific user identity package associated with this particular service provider.

At step 318, the identity authentication system may be configured to store, to a blockchain or other ledger storage, or in some embodiments, secure internal memory, information indicative of one or more of (i) the request for the user identity package and the service provider from which the request for the user identity package was received, (ii) information indicative of the return, in response to the request to the service provider, of the service-provider-specific user identity package and the service provider to which the return was transmitted and from which the request for the user identity package was received. In some embodiments, the stored information may be indexed by the device identification information or a hash of the device identification information.

At step 320, if user has not previously opted-in or out of authorizing the service provider to receive a service provider specific user identify package, the user may be prompted by the service provider to opt-in to the service (e.g., the release of verified identity information).

Step 322 shows a step where a user may submit identity attributes to the identity authentication system, or a user identity package manager, independently from service provider interactions. Step 324 shows that identity attributes may be provided via other methods, for example, by submitting documents (e.g., a driver's license, birth certification, or the like).

Step 326 shows that the identity authentication system, or a user identity package manager, may independently store, to a blockchain or other ledger storage, or in some embodiments, secure internal memory, information indicative the user attributes, for example, provided by the user and information indicative of selection of particular attributes authorized for release to particular service providers. In some embodiments, the stored information may be indexed by the device identification information or a hash of the device identification information.

An identity package, or in some embodiments, a service provider specific user identity package, comprises a set of identity attributes selected by the user. An identity package can be null if the user has not opted-in to release any identity information to a particular service provider. A minimal non-null set verifies anonymous unique identity. In some embodiments, the user selects the particular set of identity attributes to be shared for each service provider. In some embodiments, an identity package may comprise a badge (i.e., graphics or selection index), and other user-selected identity attributes.

### Example Operations for Implementing Embodiments of the Present Invention

In some embodiments, the system may be configured for facilitating release of user identity attributes during internet transactions, and in particular, the selective release of verified, authenticated, and authorized for release user identity attributes.

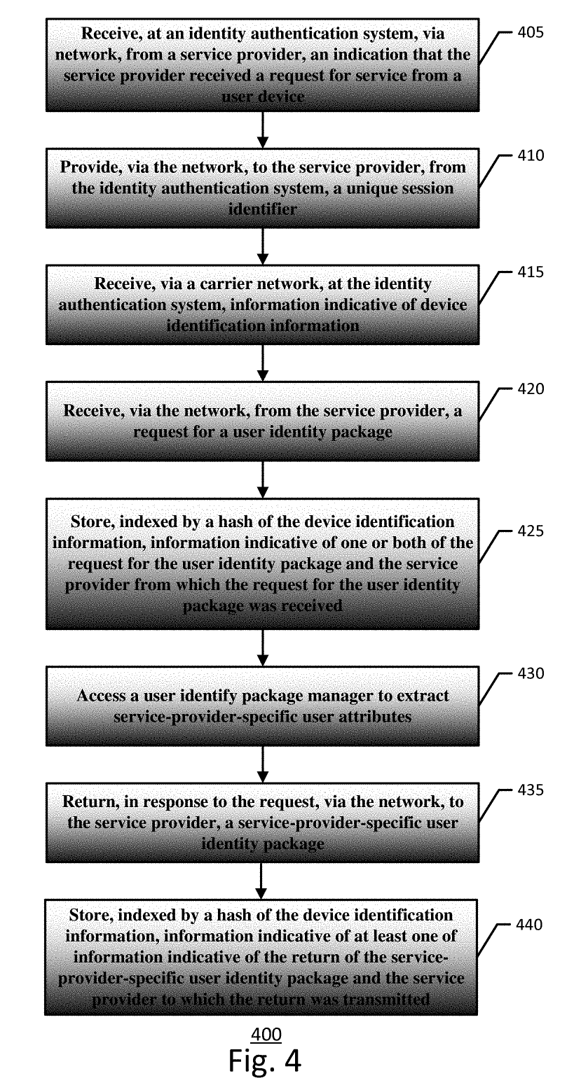

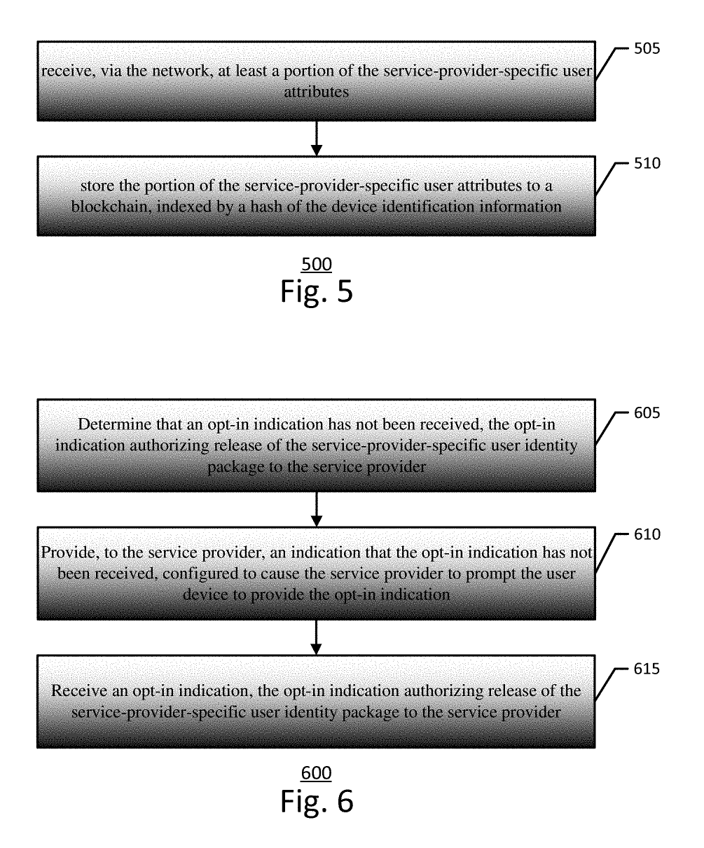

FIG. 4 shows a flowchart depicting an exemplary process 400 for authenticating a user identity and releasing verified user identity attributes, in accordance with embodiments of the present invention. FIGS. 5, 6, and 7 show flowcharts depicting example operations for other, optional, and related processes.

Returning to FIG. 4 which, in particular, shows a process in which a service-provider-specific user identity package is provided in response to a request, from a service provider, that, for example, received a request for service from a user device. The process 400 may be performed by an apparatus, such as the apparatus 200 described above with respect to FIG. 2.

As shown in block 405 of FIG. 4, an apparatus, for example, apparatus 200 embodied by, for example, identity authentication system, server 104, or the like, may be configured to receive, at an identity authentication system, via network, from a service provider, an indication that the service provider received a request for service from a user device. In some embodiments, a determination as to whether the user has opted-in. FIG. 6 describes, in more detail, how the process is performed.

In some embodiments, the request may be acknowledged. In some embodiments, as shown in block 410 of FIG. 4, an apparatus, for example, apparatus 200 embodied by, for example, identity authentication system, server 104, or the like, may be configured to provide, via the network, to the service provider, from the identity authentication system, a unique session identifier.

As shown in block 415 of FIG. 4, an apparatus, for example, apparatus 200 embodied by, for example, identity authentication system, server 104, or the like, may be configured to receive, via a carrier network, at the identity authentication system, information indicative of device identification information. In some embodiments, the device identification information is a mobile phone number associated with the user device. In some embodiments, extract the device identification information (e.g., the mobile phone number) from a signal provided to the identity authentication system, from the user device, via the carrier network. Whereas in other embodiments, the user device may provide a signal authorizing a network provider to provide the identification information to the identity authentication system and as such, receive, from the network provider, the device identification information. In some embodiments, a call (e.g., JavaScript or other call) may be made to acquire the device identification information (e.g., the mobile phone number, or the like). In any event, the identity authentication system is now able to match, determine, or identity user attributes based on the device identification information to, for example, extract and/or package those user attributes that have been selected by the user as authorized to provide to the service provider (e.g., the particular service provider that provided the indication that service was requested).

As shown in block 420 of FIG. 4, an apparatus, for example, apparatus 200 embodied by, for example, identity authentication system, server 104, or the like, may be configured to receive, via the network, from the service provider, a request for a user identity package.

In some embodiments, the receiving of the indication that the service provider received a request for service from the user device and the receiving, via the network, from the service provider, of the request for a user identity package, occur simultaneously, contemporaneously, reversed, or are the same step.

As shown in block 425 of FIG. 4, an apparatus, for example, apparatus 200 embodied by, for example, identity authentication system, server 104, or the like, may be configured to store, to internal memory or, in some embodiments a blockchain, for example, indexed by the device identification information or a hash of the device identification information, information indicative of at least one of or one or both of the request for the user identity package and the service provider from which the request for the user identity package was received.

As shown in block 430 of FIG. 4, an apparatus, for example, apparatus 200 embodied by, for example, identity authentication system, server 104, or the like, may be configured to access a user identify package manager to extract service-provider-specific user attributes. That is, utilizing the device identification information, the identity authentication system may search for, identify, or otherwise determine the user attributes that are related to, unique to, and/or have been selected by the user as authorized to provide to the service provider (e.g., the particular service provider that provided the indication that service was requested). Attributes, as used herein, may include data elements that include both a property (e.g., last name) and a property value (e.g., Smith). In some embodiments, the service-provider-specific user identity package may additionally or alternatively comprise a badge, or information indicative of a particular value for matching to a service provider specific graphic, or the like.

It should be noted here, that one or more different service providers may each have a particular set of user attributes that have been selected, for example, by the user as authorized to provide to each particular service provider, and that specific individual attributes may be included in each of one or more of the sets. Some sets of user attributes may be the same and some sets of user attributes may be different. In some embodiments, the identity authentication system may be configured to restrict the release a specified set of attributes for each of one or more service providers until opting out, for a specified time period, or for a single transaction (e.g., to confirm age when making a transaction restricted by a minimum age requirement).

Once extracted, identified, or otherwise determined, generate a service-provider-specific user identity package.

As shown in block 435 of FIG. 4, an apparatus, for example, apparatus 200 embodied by, for example, identity authentication system, server 104, or the like, may be configured to return, in response to the request, via the network, to the service provider, a service-provider-specific user identity package. In some embodiments, the service-provider-specific user identity package comprises information indicative of a set of identity attributes, the set of identity attributes comprised of one or more identity attributes selected by the user, for example, as authorized to be released to the service provider.

As shown in block 440 of FIG. 4, an apparatus, for example, apparatus 200 embodied by, for example, identity authentication system, server 104, or the like, may be configured to store, to internal memory or, in some embodiments a blockchain, for example, indexed by the device identification information or a hash of the device identification information, information indicative of at least one of information indicative of the return, for example, the return being in response to the request to the service provider, of the service-provider-specific user identity package and the service provider to which the return was transmitted and from which the request for the user identity package was received.

FIG. 5 shows a flowchart depicting an exemplary process 500 for facilitating reception of user attributes, in accordance with embodiments of the present invention. In particular, FIG. 5 provides a process by which user attributes are received, in conjunction with an interaction with a service provider or independent of an interaction with a service provider, and storing the information. The process 500 may be performed by an apparatus, such as the apparatus 200 described above with respect to FIG. 2.

As shown in block 505 of FIG. 5, an apparatus, for example, apparatus 200 embodied by, for example, identity authentication system, server 104, or the like, may be configured to receive, via the network, for example at the user identify package manager, at least a portion of the service-provider-specific user attributes. That is, at the user identify package manager, one or more particular attributes, including, for example, property values (e.g., Smith, or example@domain.com) for particular properties (e.g., last name or email address, respectively) may be received.

As shown in block 510 of FIG. 5, an apparatus, for example, apparatus 200 embodied by, for example, identity authentication system, server 104, or the like, may be configured to store the portion of the service-provider-specific user attributes to a blockchain, indexed by, for example, the device identification information or a hash of the device identification information.

FIG. 6 shows a flowchart depicting an exemplary process 600 for determining whether a user has opted-in and if not, enabling the user to opt-in, in accordance with embodiments of the present invention. In particular, FIG. 6 provides a process by which it is determined whether a user has specifically provided an opt-in indication with respect to a particular service provider, and if not, providing a prompt to the user device requesting an opt-in. That is FIG. 6 provides a plurality of optional operations directed to confirming that the user has opted-in before releasing any service-provider-specific user attributes and/or a service-provider-specific user identity package. The process 600 may be performed by an apparatus, such as the apparatus 200 described above with respect to FIG. 2.

As shown in block 605 of FIG. 6, an apparatus, for example, apparatus 200 embodied by, for example, identity authentication system, server 104, or the like, may be configured to determine that an opt-in indication has not been received, the opt-in indication authorizing release of the service-provider-specific user identity package to the service provider.

As shown in block 610 of FIG. 6, an apparatus, for example, apparatus 200 embodied by, for example, identity authentication system 102, server 104, or the like, may be configured to provide, to the service provider, an indication that the opt-in indication has not been received, configured to cause the service provider to prompt the user device to provide the opt-in indication.

As shown in block 615 of FIG. 6, an apparatus, for example, apparatus 200 embodied by, for example, identity authentication system, server 104, or the like, may be configured to receive an opt-in indication, the opt-in indication authorizing release of the service-provider-specific user identity package to the service provider.

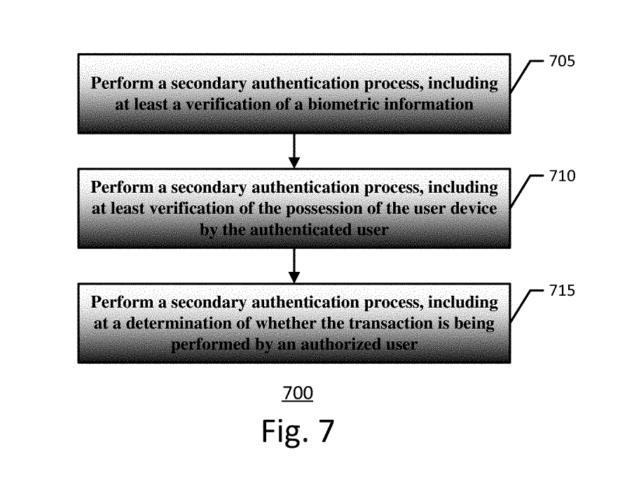

FIG. 7 shows a flowchart depicting an exemplary process 700 for performing secondary authentication, in accordance with embodiments of the present invention. In particular, FIG. 7 provides a plurality of optional operations, each aimed at further authenticating the identity of the user. The process 700 may be performed by an apparatus, such as the apparatus 200 described above with respect to FIG. 2.

As shown in block 705 of FIG. 7, an apparatus, for example, apparatus 200 embodied by, for example, identity authentication system, server 104, or the like, may be configured to perform a secondary authentication process, including at least a verification of a biometric information. For example, the apparatus may be configured to prompt for input of biometric information, via a touchscreen, fingerprint scanner, or camera, acting as, for example, fingerprint scanner or eye scanner, respectively and once received, compare the received information to information stored internally.

Additionally or alternatively, as shown in block 710 of FIG. 7, an apparatus, for example, apparatus 200 embodied by, for example, identity authentication system, server 104, or the like, may be configured to perform a secondary authentication process, including at least verification of the possession of the user device by the authenticated user. In some embodiments, user device possession can also be confirmed by user entry of biometric information into the device, by carrier signaling (authorized usage, header-injection/enrichment, or other in-band or out-of-band techniques), by user response to a query from an application running on the device, by user response to an SMS or other message received on the device, by an authentication event when logging into an Internet service, or by other techniques.

And additionally or alternatively, as shown in block 715 of FIG. 7, an apparatus, for example, apparatus 200 embodied by, for example, identity authentication system 102, server 104, or the like, may be configured to perform a secondary authentication process, including at least a determination of whether the transaction is being performed by an authorized user. That is, in some embodiments, before releasing the service-provider-specific user identity package, the system may perform or utilize a second system to perform a calculation or determination of one or more factors that may be informative and/or determinative of whether the transaction is being performed by an authorized user. For example, embodiments of the present invention may be configured to determine a likelihood that the transaction is being performed by an authorized user. In some embodiments, the likelihood that the transaction is being performed by an authorized user may be calculated as a function of a co-location probability. In some embodiments, the likelihood that the transaction is being performed by an authorized user may be calculated as a function of a co-location probability coupled with a device-possession probability. While in some embodiments, the likelihood that the transaction is being performed by an authorized user may be calculated as a function of a device-possession probability. U.S. patent application Ser. No. 16/298,176, filed Mar. 1, 2019, entitled “Using Location Paths Of User-Possessed Devices To Increase Transaction Security”, which is hereby incorporated by reference in its entirety, describes a number of exemplary processes for performing a determination of whether the transaction is being performed by an authorized user.

### Other Embodiments and Information

Single Login

In some embodiments, utilization of the identity authentication system may enable multiple, independent websites and/or apps to now be seamlessly linked together, for example, via at least an obfuscated mobile phone number or a user's anonymous unique identity information, without the hassle of each of the independent websites or apps having their own unique login credentials. That is, while conventional “single sign-on” systems have a shared login, which essentially acts as a single gate that then allows a user to access N sites after the user providers the login information and is passed through the one single sign-on gate. In contrast, here, the identity authentication system provides a flat universal common gateway, such that the gateway is provided by the system using mobile phone telephone number, hashed or plain text, acquired from the wireless carrier (or by other means), not with a single sign on that the user needs to manually pass through.

Submission of Documents

In addition to uniquely and anonymously identifying a user as real, the identity authentication system may provide for the submission, for example, by a user, wireless carrier, or other entity, of enhanced identification information (e.g., documents in physical or electronic form). Information in such documents may be attributes of the user's identity. These identity attributes may then be associated with the user by the identity authentication system and may be be released under the user's control, in conjunction with the processes described herein. The opt-in process to release such identity attributes allows the user to restrict the release a specified set of attributes for each of one or more service providers either in perpetuity, for a time period, or for a single transaction (e.g., to confirm age when making a transaction restricted by a minimum age requirement).

Coupling

A service provider's (website, application, social media network, or other Internet destination) name space (i.e. the universe on Facebook) may have custom loginIDs (including user names). A user's LoginID inside one Service Provider's name space (i.e., Twitter) may be the same loginID that the user has on another service provider, or the user may have a different LoginID. The identity authentication system described herein, utilizing, for example, an obscured ID based on a hashed, or otherwise obfuscated, phone number), may be used to couple the user's identity badges and/or other related information, across multiple, different service providers, whether the user has the same or different LoginIDs across multiple different service providers. As such, in this way, the system may be enabled to connect the identity sub-elements of a user (based on the system's method of identifying a user) across independent service providers whether the LoginIDs of those independent service providers are the same or different user LoginIDs. In contrast to conventional systems, where user characteristics are stored and those associated only within a single LoginID of a single service provider are kept, the identity authentication system described herein allows service providers to retain a user's unique LoginID, while allowing certain characteristics to be shared and inherited across multiples service providers.

Generating a Confidence Level

In one embodiment, the system generated confidence level of a user's identity is reflected by a graphic image displayed as a badge associated with a user's submitted transaction (posting, article, comment, etc.) For example, a red icon indicates no authentication, yellow indicates basic anonymous uniqueness, and green indicates the system has confirmed third party identification documents, such as a driver's license or passport, verifying the real identity of the user. In some embodiments, further identification granularity may be displayed by rolling over, clicking, or otherwise activating a display of the components that have been considered in the confidence level. For example, after clicking on a green identity badge icon, a window may open showing that the user's unique telephone number was verified at time of submitting transaction and that there is a confirmed passport associated with the telephone number.

In some embodiments, when the system is used for universal login, the reduced barrier to logging in to multiple services reduces user frustration and increases engagement with Internet services. Each service provider may then check the user's identity confidence level before granting the user services. In some embodiments, service providers may determine or otherwise provide information indicative of a level that is required for each service they provide. For example, a social media site may allow a user to login solely with the base level of anonymous identity, possibly also requiring biometric confirmation on the mobile device. A bank would likely require a much higher level of identity confidence level (and possibly requiring minimal subsets of confirmed identity attributes—for example, a passport, or a driver's license combined with a phone number linked utility account) for user login and possibly an even higher level for high-value transactions.

Some sites and/or apps (e.g., a social media Internet site or app) may use the system to enforce policy restricting users to a single account with site policy, for example, stating, requiring authentication, even where users choose to remain anonymous.

Scoring, Ranking, and/or Filtering of Content Submission

In some embodiments, the identity authentication system may be used to score, rank, and/or filter a contributor's content submission (e.g., news or other content items) using the contributor's identity confidence level, identity attributes, or other system outputs including contributor's location, reputation (e.g., determined by feedback from prior submitted articles or other sources). In some embodiments, media placement may be determined by this scoring, ranking, and/or filtering. A point-based scoring system can be created to “score” the contributor and and/or the contributor's content submission. For example, if a contributor's identity has a low verification score, combined with a score of the submission of that individual's media element (e.g., the location of the mobile phone when the contributor uploaded that submission piece of content). This overall “content credibility score rating” may then be used to filter and/or rank, or otherwise determine the placement, of that piece of content within the consumer's view. The credibility score may be further used to decide whether or not to offer the consumer other actions, for example like offering the consumer to “share” this piece of content or not. For example, content with a low credibility ranking, may not be able to be shared or not be able to be shared as easily as content with a higher credibility ranking.

Securing Privacy

Securing the privacy of user information and of transaction records is of paramount importance. The design of the identity authentication system minimizes the storage of Personally Identifiable Information (PII) to that which is minimally necessary. In some embodiments, mobile phone numbers are stored in hashed form. And because some service providers retain PII of their users, the identity authentication system may store or provide service provider specific hashes of mobile phone numbers. Because if the service provider had access to a hashed telephone number, or the hash algorithm, a data breach at such a service provider might allow other participating service providers to link their user's hashed telephone numbers to the breached PII, presuming breached data was published or somehow acquired by those other service providers. For this reason, it is anticipated that the system will not share universally hashed phone numbers with its service providers, but instead may be processed into a service provider specific re-hash. By minimizing the storage of PII, the damage from any breach is minimized and the information required to be released for compliance with law enforcement subpoenas are minimized.

Enhanced Identity

Further enhancements to user identity may be supplied by implicit testimonial, for example if a user has at least a certain threshold number of social media site friends that have basic (or enhanced) levels of identity (or in other words, are known by the system), then that user has achieved an identity certification item that factors positively into their identity confidence rating. Other identity enhancements can be submitted by the user (or the system, a service provider, or other external entity) and validated manually or by other means, including TSA Pre-check membership, CLEAR membership, driver's license, passport, wireless carrier account information (e.g., name, address, length of time at address, age of account), credit card information, credit report, social rating, possession of a FIDO USB key, etc. manual verification, when required, can be performed by trusted parties, such as the US Postal Service using their existing identity confirmation system. User identity may also be dynamically enhanced on a temporary basis, for example when the user submits biometrics (e.g., via fingerprint, face scan, retina scan, etc.) to the mobile device (e.g., either to unlock the device or to be passed through to the system), the system recognizes and records the event and the user's identity confidence level is increased for a period of time, or possibly until the mobile device is locked.

In some embodiments, enhanced credentials are available to a user at a system provided “credential store” through which users can buy enhancements to their identity, and possibly represented as additional badges, variation in the ‘basic’ identity badge, or shown when the identity badge is ‘opened’. The system may be integrated through APIs and business agreements with outside identity vendors (e.g., DMV, Equifax, Passport office, Post office, or others). Some services providers, such as credit card firms, may offer to provide these enhanced identity verifications to users (e.g., customers or applicants) for free as an inducement to sufficiently identify themselves and to opt-in to providing sufficient identity attributes to the service provider to allow services to be sold to the user, such as a credit card.

Security Via Challenge Verification

While it is possible for a bot farm to obtain a multitude of devices with valid phone numbers and to thereby easily obtain from the system the base level identity of anonymous and unique, the identity authentication system may detect bot farm behavior using artificial intelligence or other means, and subsequently perform challenge verification of the user, for example, if fraud is suspected. For example, if suspicious behavior is detected, the identity authentication system may send a message to the user device, or otherwise prompt the user, via the user device, requesting performance of some action (e.g., requesting a ‘selfie’ photograph, for example, holding up a system-determined number of fingers). The system may then examine the information provided in response to the request (e.g., examine the photograph for compliance). Failure to verify may then flag the user and/or mobile phone number as potentially fraudulent.

Use Case

The system may be applied on social media sites or apps in a variety of ways. For example, a reader could be shown an identity icon next to each post, only next to posts authored by people that are not a known friend, on comments posted on alleged news articles. Comments could be sorted by the viewer or by the publisher based on the identity confidence level of the authors of the comments. The tally next to an article could show the number of “likes” broken down by identity confidence level. For example, if an article had 105 k likes unverified, and 800 likes identity verified, it would be an indicator to the reader that the article's display relevance had been enhanced artificially, possibly by bots or troll farm workers. The reliability of online ratings can be enhanced by the system by limiting each user to the submission of a single review.

FIGS. 4, 5, 6, and 7 illustrate example flowcharts of the example operations performed by a method, apparatus, and computer program product in accordance with embodiments of the present invention. It will be understood that each block of the flowcharts, and combinations of blocks in the flowcharts, may be implemented by various means, such as hardware, firmware, processor, circuitry, and/or other devices associated with execution of software including one or more computer program instructions.

For example, in reference to FIGS. 4, 5, 6, and 7, one or more of the procedures described herein may be embodied by computer program instructions. In this regard, the computer program instructions which embody the procedures described above may be stored by a memory 216 of an apparatus employing an embodiment of the present invention and executed by a processor 202 in the apparatus.

As will be appreciated by one of ordinary skill in the art, any such computer program instructions may be loaded onto a computer or other programmable apparatus (e.g., hardware) to produce a machine, such that the resulting computer or other programmable apparatus provides for implementation of the functions specified in the block(s) of the corresponding flowchart. These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the block(s) of the flowchart. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the block(s) of the flowchart. As such, the operations of FIGS. 4, 5, 6, and 7 when executed, convert a computer or processing circuitry into a particular machine configured to perform an example embodiment of the present invention. Accordingly, the operations of FIGS. 4, 5, 6, and 7 define an algorithm for configuring a computer or processing circuitry to perform an example embodiment.

Accordingly, blocks of the flowchart support combinations of means for performing the specified functions and combinations of operations for performing the specified functions. It will also be understood that one or more blocks of the flowchart, and combination of blocks in the flowchart, can be implemented by special-purpose hardware-based computer systems which perform the specified functions, or combinations of special purpose hardware and computer instructions.

In some embodiments, certain ones of the operations herein may be modified or further amplified as described below. Moreover, in some embodiments, additional optional operations may also be included. It should be appreciated that each of the modifications, optional additions, or amplifications below may be included with the operations above either alone or in combination with any others among the features described herein.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for facilitating release of verified user identity attributes during internet transactions, the method comprising:
receiving, at an identity authentication system, via network, from a service provider, an indication that the service provider received a request for service from a user device;
receiving, via a carrier network, at the identity authentication system, information indicative of device identification information;
receiving, via the network, from the service provider, a request for a user identity package;
accessing a user identify package manager to extract service-provider-specific user attributes; and
returning, in response to the request, via the network, to the service provider, a service-provider-specific user identity package.

2. The method of claim 1, wherein the device identification information is a mobile phone number associated with the user device.

3. The method of claim 1, wherein the service-provider-specific user identity package comprises information indicative of a set of identity attributes selected by the user.

4. The method of claim 1, further comprising:
receiving an opt-in indication, the opt-in indication authorizing release of the service-provider-specific user identity package to the service provider.

5. The method of claim 1, further comprising:
determining that an opt-in indication has not been received, the opt-in indication authorizing release of the service-provider-specific user identity package to the service provider; and
providing, to the service provider, an indication that the opt-in indication has not been received, configured to cause the service provider to prompt the user device to provide the opt-in indication.

6. The method of claim 1, further comprising:
performing a secondary authentication process, including a verification of a biometric information.

7. The method of claim 1, further comprising:
receiving, at the user identify package manager, at least a portion of the service-provider-specific user attributes.

8. The method of claim 7, further comprising:
storing the portion of the service-provider-specific user attributes to a blockchain, indexed by a hash of the device identification information.

9. The method of claim 1, further comprising:
storing, to a blockchain, and indexed by a hash of the device identification information, information indicative of at least one of the request for the user identity package and the service provider from which the request for the user identity package was received.

10. The method of claim 1, further comprising:
storing, to a blockchain, and indexed by a hash of the device identification information, information indicative of at least one of information indicative of the return, in response to the request to the service provider, of the service-provider-specific user identity package and the service provider to which the return was transmitted and from which the request for the user identity package was received.

11. An apparatus for facilitating release of verified user identity attributes during internet transactions, the apparatus comprising at least one processor and at least one memory including computer program code, the at least one memory and the computer program code configured to, with the processor, cause the apparatus to at least:
receive, at an identity authentication system, via network, from a service provider, an indication that the service provider received a request for service from a user device;
receive, via a carrier network, at the identity authentication system, information indicative of device identification information;
receive, via the network, from the service provider, a request for a user identity package;
access a user identify package manager to extract service-provider-specific user attributes; and
return, in response to the request, via the network, to the service provider, a service-provider-specific user identity package.

12. The apparatus of claim 11, wherein the device identification information is a mobile phone number associated with the user device.

13. The apparatus of claim 11, wherein the service-provider-specific user identity package comprises information indicative of a set of identity attributes selected by the user.

14. The apparatus of claim 11, wherein the at least one memory and the computer program code are further configured to, with the processor, cause the apparatus to:
receive an opt-in indication, the opt-in indication authorizing release of the service-provider-specific user identity package to the service provider.

15. The apparatus of claim 11, wherein the at least one memory and the computer program code are further configured to, with the processor, cause the apparatus to:
determine that an opt-in indication has not been received, the opt-in indication authorizing release of the service-provider-specific user identity package to the service provider; and
provide, to the service provider, an indication that the opt-in indication has not been received, configured to cause the service provider to prompt the user device to provide the opt-in indication.

16. The apparatus of claim 11, wherein the at least one memory and the computer program code are further configured to, with the processor, cause the apparatus to:
perform a secondary authentication process, including a verification of a biometric information.

17. The apparatus of claim 11, wherein the at least one memory and the computer program code are further configured to, with the processor, cause the apparatus to:
receive, at the user identify package manager, at least a portion of the service-provider-specific user attributes.

18. The apparatus of claim 17, wherein the at least one memory and the computer program code are further configured to, with the processor, cause the apparatus to:
store the portion of the service-provider-specific user attributes to a blockchain, indexed by a hash of the device identification information.

19. The apparatus of claim 11, wherein the at least one memory and the computer program code are further configured to, with the processor, cause the apparatus to:
store, to a blockchain, and indexed by a hash of the device identification information, information indicative of at least one of the request for the user identity package and the service provider from which the request for the user identity package was received.

20. The apparatus of claim 11, wherein the at least one memory and the computer program code are further configured to, with the processor, cause the apparatus to:
store, to a blockchain, and indexed by a hash of the device identification information, information indicative of at least one of information indicative of the return, in response to the request to the service provider, of the service-provider-specific user identity package and the service provider to which the return was transmitted and from which the request for the user identity package was received.

21. A computer program product configured for facilitating release of verified user identity attributes during internet transactions, the computer program product comprising at least one non-transitory computer-readable storage medium having computer-executable program code instructions stored therein, the computer-executable program code instructions comprising program code instructions for:
receiving, at an identity authentication system, via network, from a service provider, an indication that the service provider received a request for service from a user device;
receiving, via a carrier network, at the identity authentication system, information indicative of device identification information;
receiving, via the network, from the service provider, a request for a user identity package;
accessing a user identify package manager to extract service-provider-specific user attributes; and
returning, in response to the request, via the network, to the service provider, a service-provider-specific user identity package.

22. The computer program product of claim 21, wherein the device identification information is a mobile phone number associated with the user device.

23. The computer program product of claim 21, wherein the service-provider-specific user identity package comprises information indicative of a set of identity attributes selected by the user.

24. The computer program product of claim 21, wherein the computer-executable program code instructions further comprise program code instructions for:
receiving an opt-in indication, the opt-in indication authorizing release of the service-provider-specific user identity package to the service provider.

25. The computer program product of claim 21, wherein the computer-executable program code instructions further comprise program code instructions for:
determining that an opt-in indication has not been received, the opt-in indication authorizing release of the service-provider-specific user identity package to the service provider; and
providing, to the service provider, an indication that the opt-in indication has not been received, configured to cause the service provider to prompt the user device to provide the opt-in indication.

26. The computer program product of claim 21, wherein the computer-executable program code instructions further comprise program code instructions for:
performing a secondary authentication process, including a verification of a biometric information.

27. The computer program product of claim 21, wherein the computer-executable program code instructions further comprise program code instructions for:
receiving, at the user identify package manager, at least a portion of the service-provider-specific user attributes.

28. The computer program product of claim 27, wherein the computer-executable program code instructions further comprise program code instructions for:
storing the portion of the service-provider-specific user attributes to a blockchain, indexed by a hash of the device identification information.

29. The computer program product of claim 21, wherein the computer-executable program code instructions further comprise program code instructions for:
storing, to a blockchain, and indexed by a hash of the device identification information, information indicative of at least one of the request for the user identity package and the service provider from which the request for the user identity package was received.

30. The computer program product of claim 21, wherein the computer-executable program code instructions further comprise program code instructions for:
storing, to a blockchain, and indexed by a hash of the device identification information, information indicative of at least one of information indicative of the return, in response to the request to the service provider, of the service-provider-specific user identity package and the service provider to which the return was transmitted and from which the request for the user identity package was received.
